(19) United States
(12) Patent Application Publication
(10) Pub. No.: US 2016/0309507 A1
(43) Pub. Date: Oct. 20, 2016

(54) METHOD AND APPARATUS FOR RANDOM ACCESS IN MACHINE TYPE COMMUNICATION NETWORK

(71) Applicant: Electronics and Telecommunications Research Institute, Daejeon (KR)

(72) Inventor: Ok-Sun PARK, Daejeon (KR)

(21) Appl. No.: 15/098,952

(22) Filed: Apr. 14, 2016

(30) Foreign Application Priority Data
Apr. 14, 2015 (KR) 10-2015-0052725
Jun. 8, 2015 (KR) 10-2015-0080820
Apr. 14, 2016 (KR) 10-2016-0045675

(51) Int. Cl. H04W 74/00; H04W 74/08; H04W 4/00

(52) U.S. Cl. CPC H04W 74/006; H04W 4/005; H04W 74/004; H04W 74/0833

(57) ABSTRACT

A method for random access includes transmitting a preamble to a base station; receiving a first random access response (RAR) message of at least one RAR messages which is multiplexed by the base station based on the preamble from the base station; and transmitting a scheduled message based on the first RAR message to the base station, wherein the first RAR message is addressed to the terminal, an apparatus, and a method for supporting random access of the terminal are provided.

### CROSS-REFERENCE TO RELATED APPLICATION

This application claims priority to and the benefit of Korean Patent Application Nos. 10-2015-0052725, 10-2015-0080820, and 10-2016-0045675 filed in the Korean Intellectual Property Office on Apr. 14, 2015, Jun. 8, 2015, and Apr. 14, 2016, the entire contents of which are incorporated herein by reference.

### BACKGROUND OF THE INVENTION

(a) Field of the Invention

The present invention relates to an apparatus and a method for random accessing in machine type communication network

(b) Description of the Related Art

The design objectives of a machine type communication (MTC) terminal are low-cost and low-energy. Therefore, the MTC terminal has a single antenna and transmits data with a narrow band, and the data may be aperiodically transmitted.

Generally, as the MTC terminal provides a service which periodically sends data less than 1000 bits at least several seconds, the request for the delay time is low, but the number of terminals that connects to a base station may be rising explosively.

Because the mobile communication system based on an orthogonal frequency division multiplexing (OFDM) is optimized to a high-speed data transmission, the wireless resource to provide a service to massive MTC terminals is not enough.

In addition, if the signaling procedure of a general purpose mobile terminal is applied to the MTC terminal, the signaling overhead for resolving the contention is too large compared to the size of the data transmitted by the MTC terminal.

Therefore, even if the delay time increases, it is necessary to reduce the signaling procedure of the MTC terminal or the load to the control resources.

### SUMMARY OF THE INVENTION

An exemplary embodiment has been made in an effort to provide a method for performing a random access of MTC terminal. Another exemplary embodiment has been made in an effort to provide a MTC terminal which performs a random access. Still another exemplary embodiment has been made in an effort to provide a method for supporting a random access of base station.

An exemplary embodiment provides a method for random access of a terminal, the method including: transmitting a preamble to a base station; receiving a first random access response (RAR) message of at least one RAR messages which is multiplexed by the base station based on the preamble from the base station; and transmitting a scheduled message based on the first RAR message to the base station, wherein the first RAR message is addressed to the terminal.

The terminal may be a machine type communication (MTC) terminal, and the receiving may include receiving the first RAR message carried by downlink control information (DCI) of a physical downlink control channel for MTC (M-PDCCH).

The terminal may be a machine type communication (MTC) terminal, and the receiving may include receiving the first RAR message through a physical downlink shared channel (PDSCH) which is scheduled by a physical downlink control channel for MTC (M-PDCCH).

The at least one RAR message may include a media access control (MAC) header and a RAR payload, and the RAR payload may include at least one of a temporary C-RNTI (TC-RNTI), a timing advance (TA), or an uplink grant (UL grant).

A DCI format of the DCI may include a random access preamble identifier (RAPID) or a backoff indicator (BI).

The DCI format may further include a timing advance (TA) and a user equipment identifier (UE identifier).

The transmitting a preamble to a base station may include selecting the preamble in a group of a plurality of groups, and transmitting the selected preamble.

A first group of the plurality of groups may include at least one preamble which is to be used for initial access to a network by the terminal, and a second group of the plurality of groups may include at least one preamble which is to be used for re-access to the network by the terminal.

The method may further include: receiving parameters pertinent to a random access channel (RACH) from the base station before transmitting the preamble, wherein the parameters pertinent to the RACH may include at least one of group information of a machine type communication (MTC) preamble, a repetition level of the RACH, an MTC RA response Window Size, or an MTC contention resolution timer.

Another embodiment provides a terminal for performing random access including: at least one processor; a memory; and a wireless communication unit, wherein the at least one processor executes at least one program stored in the memory to perform: transmitting a preamble to a base station; receiving a first random access response (RAR) message of at least one RAR messages which is multiplexed by the base station based on the preamble from the base station; and transmitting a scheduled message based on the first RAR message to the base station, wherein the first RAR message is addressed to the terminal.

The terminal may be a machine type communication (MTC) terminal, and during the receiving, the at least one processor may perform receiving the first RAR message carried by downlink control information (DCI) of a physical downlink control channel for MTC (M-PDCCH).

The terminal may be a machine type communication (MTC) terminal, and during the receiving, the at least one processor may perform receiving the first RAR message through a physical downlink shared channel (PDSCH) which is scheduled by a physical downlink control channel for MTC (M-PDCCH).

The at least one RAR message may include a media access control (MAC) header and a RAR payload, and the RAR payload may include at least one of a temporary C-RNTI (TC-RNTI), a timing advance (TA), or an uplink grant (UL grant).

A DCI format of the DCI may include a random access preamble identifier (RAPID) or a backoff indicator (BI).

The DCI format may further include a timing advance (TA) and a user equipment identifier (UE identifier).

During the transmitting, the at least one processor may perform selecting the preamble in a group of a plurality of groups, and transmitting the selected preamble.

A first group of the plurality of groups may include at least one preamble which is to be used for initial access to a network by the terminal, and a second group of the plurality of groups may include at least one preamble which is to be used for re-access to the network by the terminal.

The at least one processor may further perform receiving parameters pertinent to a random access channel (RACH) from the base station before the transmitting the preamble, wherein the parameters pertinent to the RACH may include at least one of group information of a machine type communication (MTC) preamble, a repetition level of the RACH, an MTC RA response Window Size, or an MTC contention resolution timer.

Yet another embodiment provides a method for supporting random access of a terminal, the method including: multiplexing at least one random access response (RAR) message based on a preamble which is received from the terminal; and receiving a scheduled message based on a first RAR message of the at least one RAR message.

The method may further include: transmitting parameters pertinent to a random access channel (RACH), wherein the parameters pertinent to the RACH may include at least one of group information of a machine type communication (MTC) preamble, a repetition level of the RACH, an MTC RA response Window Size, or an MTC contention resolution timer.

### BRIEF DESCRIPTION OF THE DRAWINGS

FIG. 1 is a view illustrating a state transition diagram of an MTC terminal according to an exemplary embodiment.

FIG. 2 is a flowchart illustrating a method for RA according to an exemplary embodiment.

FIG. 3 is a flowchart illustrating the method for random access of the terminal according to an exemplary embodiment.

FIG. 4 is a schematic diagram illustrating RAR message according to an exemplary embodiment.

FIG. 5 is a schematic diagram illustrating RAR payload according to an exemplary embodiment.

FIG. 6 is a schematic diagram illustrating RAR payload according to another exemplary embodiment.

FIG. 7 is a flowchart illustrating method of random access according to another exemplary embodiment.

FIG. 8 is a flowchart illustrating a method for random access according to another exemplary embodiment.

FIG. 9 is a schematic diagram illustrating RAR payloads according to another exemplary embodiment.

FIG. 10 is a schematic diagram illustrating a re-defined DCI format according to an exemplary embodiment.

FIG. 11 is a block diagram illustrating a wireless communication system according to an exemplary embodiment.

### DETAILED DESCRIPTION OF THE EMBODIMENTS

Hereinafter, exemplary embodiments will be described in detail with reference to the accompanying drawings so that those skilled in the art may easily practice the present invention. However, the present invention may be implemented in various different ways and is not limited to the exemplary embodiments provided in the present description. In the accompanying drawings, portions unrelated to the description will be omitted in order to obviously describe the present invention, and similar reference numerals will be used to describe similar portions throughout the present specification.

Throughout the specification, a terminal may refer to a mobile station (MS), a mobile terminal (MT), an advanced mobile station (AMS), a high reliability mobile station (HR-MS), a subscriber station (SS), a portable subscriber station (PSS), an access terminal (AT), a user equipment (UE), a machine type communication (MTC) device, and the like, and may include functions of all or some of the MT, MS, AMS, HR-MS, SS, PSS, AT, UE, and the like.

In addition, a base station (BS) may represent an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as the base station, a relay node (RN) serving as the base station, an advanced relay station (ARS) serving as the base station, a high reliability relay station (HR-RS) serving as the base station, a small base station [femto base station (BS), a home node B (HNB), a home eNodeB (HeNB), a pico BS, a macro BS, a micro BS, or the like], or the like, and may include all or some of the functions of the ABS, the nodeB, the eNodeB, the AP, the RAS, the BTS, the MMR-BS, the RS, the RN, the ARS, the HR-RS, the small base station, and the like.

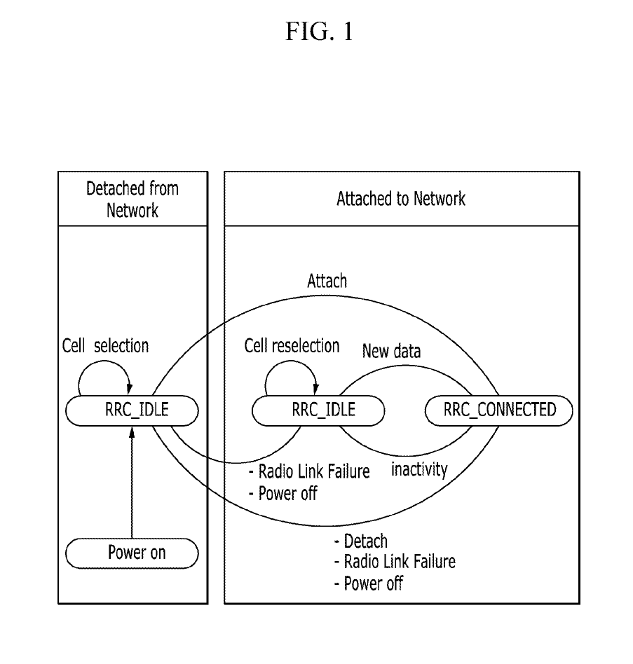

FIG. 1 is a view illustrating a state transition diagram of an MTC terminal according to an exemplary embodiment.

In a normal mobile system, a terminal performs a random access (RA) procedure to initial access/re-access to a network by using a preamble. For example, in the random access procedure of long term evolution (LTE), 64 preambles are defined in one RA resource, and the preambles are classified as a preamble for a contention-free scheme and a contention-based scheme. In the LTE system, each cell configures at least one RA resource, and the terminal device attempts to random access using the configured RA resource.

In the contention-based RA procedure, because the terminal randomly selects a preamble to transmit the preamble, there may be a collision of the preamble when a plurality of terminals simultaneously transmit the same preamble. On the other hand, because the network allocates a preamble index to the terminal in the contention-free RA procedure, the collision would not occur. The method of performing the RA procedure of MTC terminal for a network initial-access and a network re-access is described in the exemplary embodiment. The RA for the network initial-access may be performed in a different manner against the RA for the network re-access.

An RA for the terminal to attach to the network includes a RA procedure for the network initial access. The network initial access may include the cases in which the terminal attempts RA at the time the MTC devices initially installed, relocation of the installation place, or after the expiration of the period preconfigured or predetermined by the system. In this case, the preconfigured period or the predetermined period by the system is the case that a timer has been expired, or an arbitrary date or time has come. When the system controls parameters about the timer and the specific period (for example, date or time), the parameters may be signaled by using a common control message as system information or a dedicated control message. The RA may be started from the MTC terminal in a radio resource control (RRC) idle mode detached from the network.

The network re-access may include the RA for transmitting new data. Before the RA for transmitting the new data, the terminal has been attached to the network and any services has not been used by the terminal. And the RA may be started from the MTC terminal in a RRC idle mode attached to the network. That is, the RA may be started when the request of data transmission newly occurred or the MTC terminal in the idle mode initially access to the network.

The MTC terminal may perform a state transition to the idle mode to save the power consumption when the terminal does not communicate. Thereafter, the MTC terminal performs the state transition to an active mode to start the RA when the new data has occurred or the timer has been expired. According to the exemplary embodiment, the MTC terminal may perform the contention based RA for the network initial access and the network re-access. In this case, the preambles may be classified as a preamble to be used for the network initial access and to be used for the network re-access.

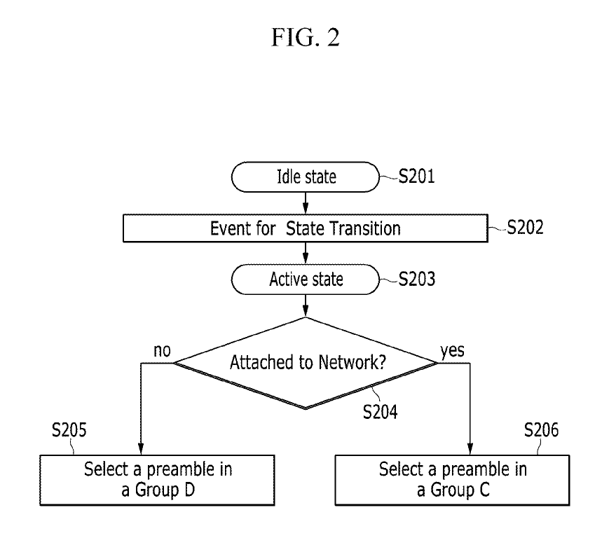

FIG. 2 is a flowchart illustrating a method for RA according to an exemplary embodiment.

Referring to FIG. 2, the MTC terminal in the idle mode (S201), when the event for the state transition has occurred (S202), performs the state transition to the active state (S203). Thereafter, the MTC terminal starts the RA procedure by selecting the preamble (S204).

In the exemplary embodiment, there are four groups (group A, group B, group C, and group D) of preambles in a cell. The group A and the group B include preambles to be used according to the data size transmitted by a normal terminal. The group C and the group D includes preambles to be used by the MTC terminal according to the connection status to the network. For example, the MTC terminal may select the preamble among the group C or the group D whether the MTC terminal has been attached to the network or not. As the group C includes the preambles to be used for the network re-access, the MTC terminal attached from the network may use the preamble included in the group C. As the group D includes the preambles to be used for the network initial access, the MTC terminal detached to the network may use the preamble included in the group D. In this case, the length of a random access response (RAR) message may be different according to each preamble group as well as the M3 message indicating the scheduled message such as the RRC connection request message.

In the exemplary embodiment, the parameters pertinent to a random access channel (RACH) for the MTC terminal are included in a system information block (SIB) for MTC. In this case, the parameters pertinent to the RACH included in the SIB may include at least one of the number of the MTC preambles dedicated to the contention-based RA, information about the preamble included in the group C, information about the preamble included in the group D, repetition level, power ramping parameter, a maximum number of the preamble transmission, an MTC RA-response Window Size information, or an MTC contention resolution timer. The MTC RA-response Window Size information and the MTC contention resolution timer may be set to a value greater than that of the normal terminals in consideration for the repetition of the PRACH transmission.

Hereinafter, the case that the MTC terminal in the RRC idle mode randomly selects the preamble in the group D to perform the network initial access (S205) will be described.

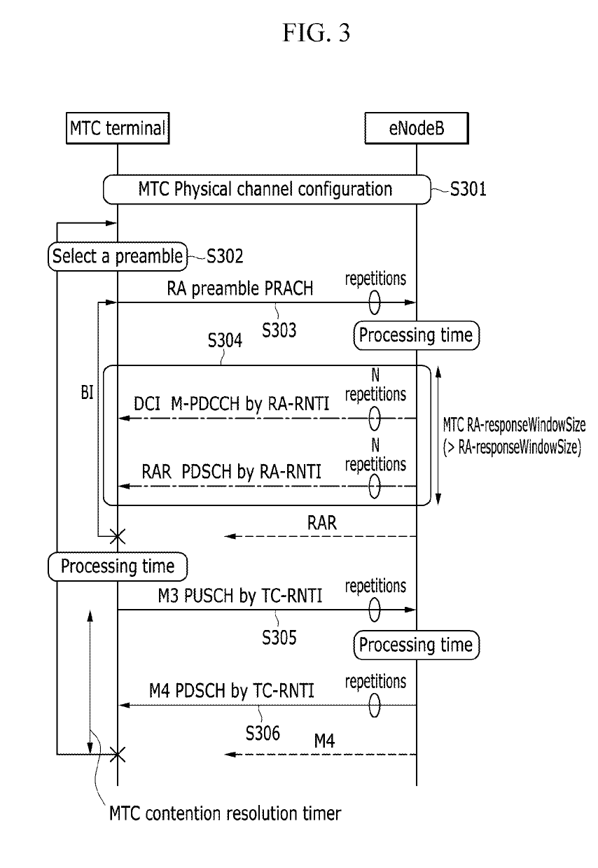

FIG. 3 is a flowchart illustrating the method for random access of the terminal according to an exemplary embodiment.

First, the physical channel is configured for the MTC between the base station and the MTC terminal by receiving for the MTC terminal from the base station (S301). Thereafter, the terminal randomly selects the preamble in the group D (S302).

The terminal transmits the RA preamble through a physical random access channel (PRACH) (S303). The time resource at which the RA preamble can be transmitted may be determined by the PRACH configuration index and the repetition level. In addition, a random access radio network temporary identity (RA-RNTI) is determined according to the subframe index and frequency resource index in which the preamble is transmitted. According to the exemplary embodiment, the RA-RNTI may be determined based on the equation 1.

RA-RNTI=1+t_{id}+10×f_{id} (Equation 1)

In the equation 1, the t_{ic}, represents the index of the subframe in which the PRACH is transmitted in first and has the value between 0-9. The f_{id} represents the index of the PRACH resource set, and has the value in ascending order.

The base station that received the preamble from the terminal determines the RA-RNTI based on the subframe in which the preamble is detected after the processing time. Thereafter, the base station transmits the physical downlink control channel for MTC (M-PDCCH) and the RAR message that are addressed by the RA-RNTI to the terminal (S304).

When the base station transmits the RAR message addressed by the RA-RNTI, the base station may multiplex two or more RAR messages simultaneously. In this case, the RAR message may be transmitted through a physical downlink shared channel (PDSCH) scheduled by the M-PDCCH. The scheduling information of the PDSCH in which the RAR message is transmitted may be transmitted N repetition times by the M-PDCCH, and the RAR message may be transmitted M repetition times by the PDSCH.

The MTC terminal according to the exemplary embodiment, if the RAR message is not received within a time duration of {minimum processing time+MTC RA-response Window Size}, may increase the repetition level of the PRACH to retransmit the PRACH including the preamble. In this case, the preamble of the S302 step may be recycled as the retransmitted preamble.

The MTC terminal according to the exemplary embodiment, if the RAR message is not received but a backoff indicator (BI) is received through a DCI of the M-PDCCH within a time duration of {minimum processing time+MTC RA-response Window Size}, may wait during the time determined according to the BI to retransmit the PRACH. For example, the MTC terminal may select an arbitrary time within the time duration indicated by the BI, and may retransmit the PRACH after waiting during the selected arbitrary time. In this case, the preamble of the S302 step may be recycled as the retransmitted preamble.

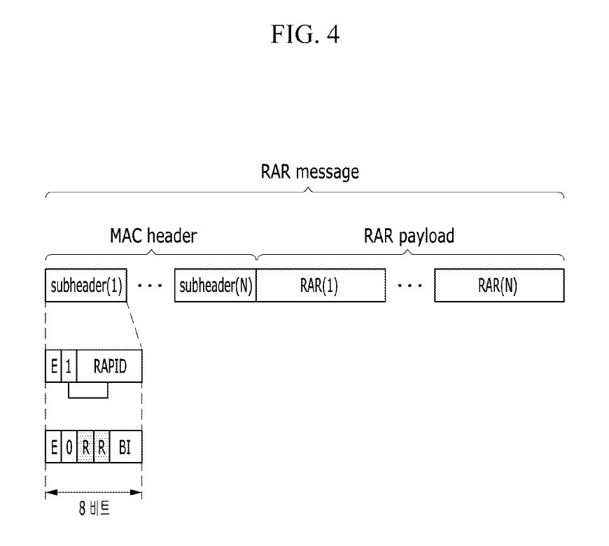

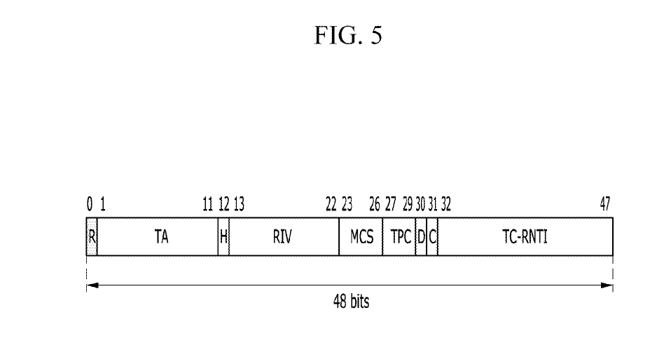

FIG. 4 is a schematic diagram illustrating RAR message according to an exemplary embodiment, and FIG. 5 is a schematic diagram illustrating RAR payload according to an exemplary embodiment.

Referring to FIG. 4, the RAR message generated in a media access control (MAC) layer of the base station includes MAC header and RAR payload. The RAR payload includes at least one of a temporary Cell-RNTI (C-RNTI), a timing advance (TA), or uplink grant information, and is octet-aligned.

Referring to FIG. 5, the RAR payload used for the RA of the network attachment procedure (at the time of initial access, relocation of the installation place, or after the expiration of the arbitrary time, etc.) is showed. For example, the RAR payload may include a reservation (1 bit), a timing advance (11 bits), Hopping flag (1 bit), Resource Indication Value (RIV) (10 bits), modulation and coding scheme (MCS) (4 bits), transmit power control (TPC) command for scheduled PUSCH (3 bits), uplink (UL) delay (1 bit), channel quality indicator (001) request (1 bit), and Temporary C-RNTI (TC-RNTI) (16 bits).

Meanwhile, the MTC terminal synchronizes the uplink time synchronization according to the TA, and transmit message 3 (M3) (for example, RRC Connection Request message) through the uplink resource allocated to the MTC terminal by the UL grant (S303). Thereafter, the contention resolution timer is started. In this case, the M3 is a scheduled message based on the RAR message. The RRC connection request message includes UE identity. In this case, as the SAE-temporary mobile subscriber identity (S-TMSI) is not allocated to the terminal yet, the UE identity is set as a random value.

The base station transmits a RRC connection setup message (that is, message 4 (M4)) addressed by the TC-RNTI to resolve a contention (S306). The RRC connection setup message includes the C-RNTI and the MTC physical channel configuration information. If the M4 is not received although the contention resolution timer has been expired, the MTC terminal selects another preamble. That is, the MTC returns to the step S302.

If the RRC connection setup message successfully received from the base station before the contention resolution timer is expired, the MTC terminal performs a state transition to RRC connected mode. In this case, the last uplink TA may be stored in the MTC terminal after the MTC terminal performs the state transition to the RRC idle mode. Thereafter, the MTC terminal in the RRC connected mode may transmit new data or perform signaling procedure.

Hereinafter, the case that the MTC terminal in the RRC idle mode randomly selects the preamble in the group C to perform the network re-access (S206) will be described. In this case, the uplink TA stored in the terminal may be applied to the uplink frame. The time resource at which the RA preamble can be transmitted may be determined by the PRACH configuration index and the repetition level. In addition, a random access radio network temporary identity (RA-RNTI) is determined according to the subframe in which the preamble is transmitted. The RA-RNTI may be determined based on the equation 1 as in S205.

Thereafter, the MTC terminal according to the exemplary embodiment, if the RAR message is not received in a time duration of {minimum processing time+MTC RA-response Window Size}, may increase the repetition level of the PRACH to restart the RA procedure.

Meanwhile, the base station may determine the RA-RNTI based on the subframe in which the preamble is detected after the processing time. Thereafter, the base station may transmit the RAR message that is addressed by the RA-RNTI to the terminal. When the base station transmits the RAR message addressed by the RA-RNTI, the base station may multiplex two or more RAR messages simultaneously. The scheduling information of the PDSCH including the RAR message may be transmitted N repetition times by the M-PDCCH, and the RAR message may be transmitted M repetition times by the PDSCH. Each MAC RAR message includes MAC header and RAR payload. Each RAR payload includes at least one of a temporary Cell-RNTI (C-RNTI), a timing advance (TA), or uplink grant information, and is octet-aligned.

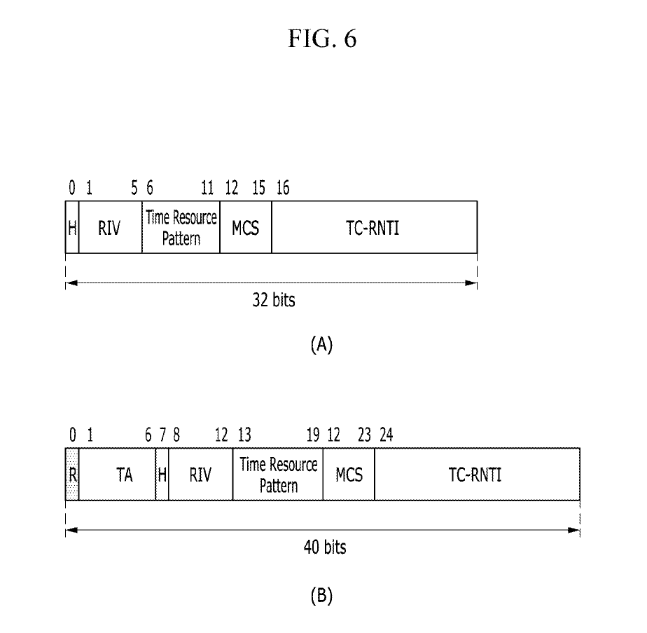

FIG. 6 is a schematic diagram illustrating RAR payload according to another exemplary embodiment.

Referring to FIG. 6, the RAR payload according to the another exemplary embodiment includes Time resource pattern (6 bits), hopping flag (H) (1 bit), RIV (5 bits), MCS (4 bits), and TC-RNTI (16 bits).

The low-cost MTC terminal supporting the 1.4 MHz bandwidth may represent the RIV by 5 bits. And, the coverage enhancement (CE) MTC terminal may need no TPC command when the preamble is transmitted by the maximum power.

Meanwhile, as the time offset is hardly changed for the stationary MTC terminal, the TA acquired in the network initial access procedure may be applied continuously. Referring to FIG. 6 (A), when the stationary MTC terminal re-uses the TA acquired in the network initial access procedure, the RAR message may not include the TA field. Referring to FIG. 6 (B), the limited mobility MTC terminal may assume that the timing offset is in 1 OFMD symbol from the TA acquired in the network initial access procedure, so that the TA acquired in the network re-access procedure may be 6 bits. In this case, the TA of the MTC terminal is updated with the TA of the last received RAR message. Therefore, in consideration of the features of the MTC terminal, the RAR message used in the network re-access procedure may be reduced by 8 bits to 16 bits, compared to the network initial access procedure.

The MTC terminal synchronizes the uplink time synchronization according to the TA, and transmit RRC Connection Request message through the uplink resource according to the RIV. The RRC connection request message includes UE identity, and may be set as the pre-allocated S-TMSI.

The base station transmits a RRC connection setup message addressed by the TC-RNTI to the terminal to resolve a contention. The RRC connection setup message includes the C-RNTI and the MTC physical channel configuration information.

If the RRC connection setup message successfully received from the base station before the contention resolution timer is expired, the MTC terminal performs a state transition to RRC connected mode. Thereafter, the MTC terminal in the RRC connected mode may transmit new data or perform signaling procedure.

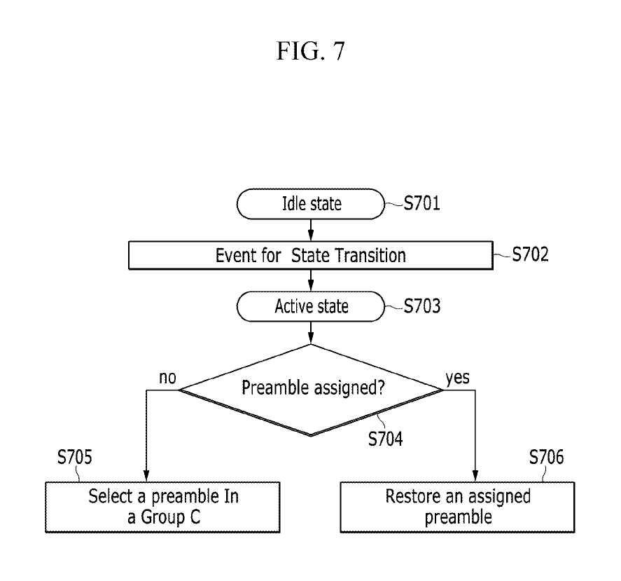

FIG. 7 is a flowchart illustrating method of random access according to another exemplary embodiment.

In the RA method illustrated in FIG. 7, some of MTC terminals of plurality of the MTC terminals may perform the contention-based RA, and the other terminals of the plurality of the MTC terminals may perform the contention free RA.

First, the MTC terminal in the idle mode (S701), when the event for the state transition has occurred (S702), performs the state transition to the active state (S703). Thereafter, the MTC terminal starts the RA procedure by selecting the preamble (S704).

In another exemplary embodiment, the preamble may be divided into three groups (group A, group B, and group C). The group A and the group B include preambles to be used according to the data size transmitted by a normal terminal. The group C includes preambles to be used by the MTC terminal.

The parameters pertinent to the RACH for the MTC terminal are included in a system information block (SIB), and may include at least one of the number of the MTC preambles dedicated to the contention-based RA, information about the preamble included in the group C, repetition level, power ramping parameter, a maximum number of the preamble transmission, an MTC RA-response Window Size information, or an MTC contention resolution timer.

The MTC terminal in the RRC idle mode randomly selects a preamble in the group C when there is no allocated preamble to the MTC terminal (S705). The time resource at which the RA preamble can be transmitted may be determined by the PRACH configuration index and the repetition level. In addition, a RA-RNTI is determined according to the subframe in which the preamble is transmitted, and may be determined based on the equation 1. When the base station transmits the RAR message addressed by the

RA-RNTI, the base station may multiplex two or more RAR messages simultaneously. The scheduling information of the PDSCH including the RAR message may be transmitted N repetition times by the M-PDCCH, and the RAR message may be transmitted M repetition times by the PDSCH. Each MAC RAR message includes MAC header and RAR payload. Each RAR payload includes at least one of a TC-RNTI, a TA, or uplink grant information, and is octet-aligned.

The MTC terminal synchronizes the uplink time synchronization according to the TA, and transmit RRC Connection Request message through the uplink resource according to the RIV. The RRC connection request message includes UE identity. In this case, as the SAE-temporary mobile subscriber identity (S-TMSI) is not allocated to the terminal yet, the UE identity may be set as a random value.

The base station transmits a RRC connection setup message addressed by the TC-RNTI to resolve a contention. In this case, the RRC connection setup message includes the C-RNTI and the MTC physical channel configuration information.

If the RRC connection setup message successfully received from the base station before the contention resolution timer is expired, the MTC terminal performs a state transition to RRC connected mode. In this case, the last uplink TA may be stored in the MTC terminal after the MTC terminal performs the state transition to the RRC idle mode. Thereafter, the MTC terminal in the RRC connected mode may transmit new data or perform signaling procedure.

The signaling procedure between the MTC terminal in the RRC connected mode and the network include a procedure that grouping the MTC terminals having an similar traffic pattern and allocating a preamble to the grouped MTC terminal. In the procedure of allocating the preamble to the terminal, the base station may additionally transmit preamble index and time information related to the RA transmission of the MTC terminal.

In this case, the time information related to the RA transmission of the MTC terminal may be represented by a subset of the available subframes according to the PRACH configuration index and the repetition level in consideration of the periodicity of the occurrence of the traffic. Hereinafter, it is described in detail.

In addition, the MTC terminal in the RRC idle mode may omit the signaling procedure for the contention resolution by transmitting the pre-allocated preamble at the predetermined time. The preamble used in this case is not included in the group A, B, and C including the preambles for the contention-based RA. And the stored uplink TA may be applied to the uplink frame.

In order to allocate the preambles uniquely to an arbitrary MTC terminal, a method in which the RA resource index and the preamble index are allocated to the arbitrary MTC terminal or the arbitrary MTC terminal group may be used. According to the above allocation method, a preamble is allocated to a MTC group including a plurality of the MTC terminals and the plurality of the MTC terminals included in the MTC group may share the allocated preamble (S706). In this case, if the plurality of the MTC terminal in the MTC group uses the preamble according to the time divisional method, the base station may distinguish the specific MTC terminal in the MTC group. For example, the transmission timing of the preamble such as represented by the radio frame or subframe in which the RA is attempted may be set for each MTC terminal of the MTC group separately by using the preamble allocated to the MTC group. In addition, the transmission timing of the preamble for each MTC terminal of the MTC group sharing the same preamble may be distinguished by the modular operation based on the system frame number (SFN), radio frame index, and subframe index. Otherwise, the transmission timing of the preamble may be distinguished by adding a unique identifier (for example, International Mobile Subscriber Identity (IMSI) or Temporary Mobile Subscriber Identity (TMSI)) to the modular operation for the transmission timing of the preamble shared in the MTC group.

Meanwhile, when a preamble is allocated to a MTC group including a plurality of the MTC terminals and the plurality of the MTC terminals included in the MTC group shares the allocated preamble, the control information about the allocated preamble and the transmission timing of the preamble of each MTC terminal may be signaled to the MTC terminal.

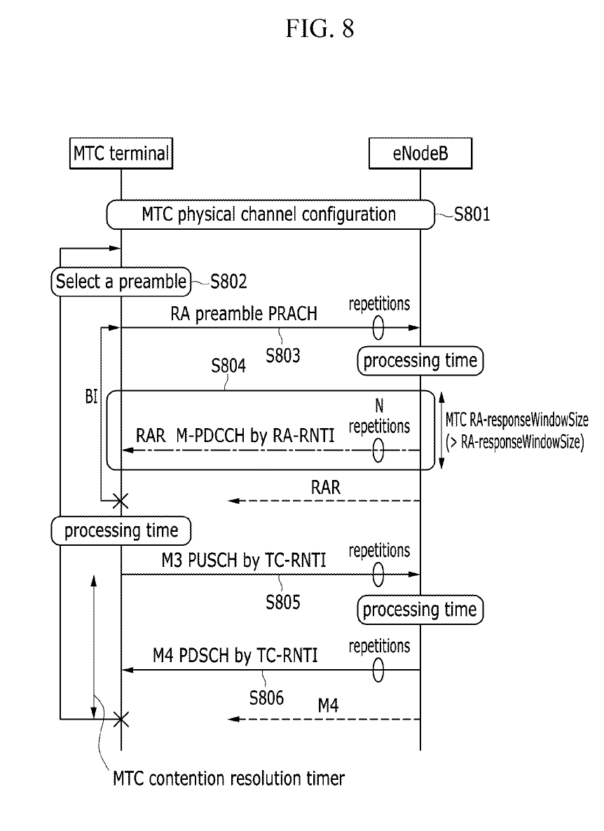

FIG. 8 is a flowchart illustrating a method for random access according to another exemplary embodiment.

First, the physical channel is configured for the MTC between the base station and the MTC terminal by receiving for the MTC terminal from the base station (S801). Thereafter, the terminal randomly selects the preamble in the group D (S802).

The terminal transmits the RA preamble through the PRACH (S803). The time resource at which the RA preamble can be transmitted may be determined by the PRACH configuration index, the repetition level, and the foregoing additional time information. In addition, the RA-RNTI is determined according to the subframe in which the preamble is transmitted. According to another exemplary embodiment, the RA-RNTI may be determined based on the equation 1.

The base station that received the preamble from the terminal determines the RA-RNTI based on the subframe in which the preamble is detected after the processing time. Thereafter, the base station transmits the RAR message that are addressed by the RA-RNTI to the terminal (S804). The RAR message includes at least one of a C-RNTI, a time resource pattern, or uplink grant information. The base station allocates the C-RNTI to the MTC terminal, and notifies uplink timing offset and uplink resource information measured from the preamble to the MTC terminal.

The MTC terminal, if the RAR message is not received in a time duration of {minimum processing time+MTC RA-response Window Size}, may increase the repetition level of the PRACH to restart the RA procedure. The retransmitted preamble in this case may be same with the selected preamble in the step S802.

The MTC terminal, if the RAR message is not received but a BI is received through a DCI of the M-PDCCH within a time duration of {minimum processing time+MTC RA-response Window Size}, may wait during the time determined according to the BI to retransmit the PRACH. For example, the MTC terminal may select an arbitrary time within the time duration indicated by the BI, and may retransmit the PRACH after waiting during the selected arbitrary time. In this case, the preamble of the S802 step may be recycled as the retransmitted preamble.

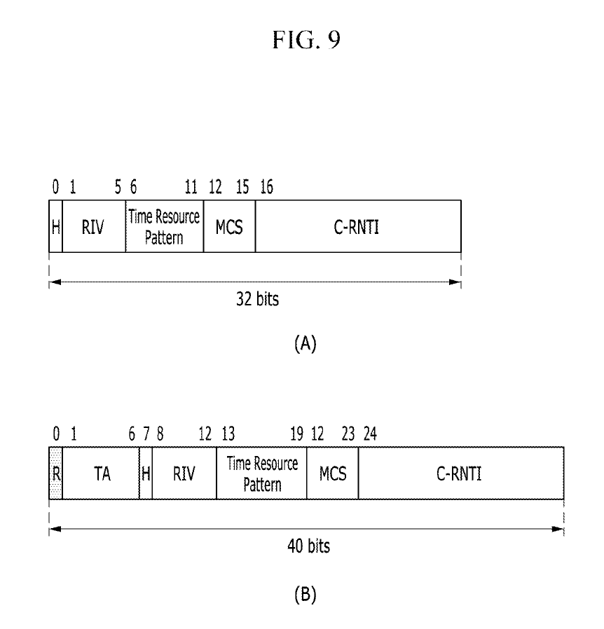

FIG. 9 is a schematic diagram illustrating RAR payloads according to another exemplary embodiment.

The RAR payload showed in FIG. 9 may be used for the MTC terminal performing the network re-access. Referring to FIG. 9, R represents reserved bits and may include uplink grant of the M3. The T in FIG. 9 is the field for distinguishing between the random access preamble identifier (RAPID) and BI.

The MTC terminal may transmit new data in a uplink resource determined based on the RIV and the time resource pattern. In this case, if necessary, the MTC terminal may transmit pre-allocated S-TMSI.

The stationary MTC terminal may continuously apply the TA acquired in the network initial access because the timing offset hardly is changed. Referring to FIG. 9 (A), because there is no need to be measured the TA when the network re-access is performed, the TA field is not included in the RAR message.

Referring to FIG. 9 (B), the limited mobility MTC terminal may assume that the timing offset is in 1 OFMD symbol from the TA acquired in the network initial access procedure, so that the TA acquired in the network re-access procedure may be 6 bits.

Referring to FIG. 9, when the base station transmits the RAR message addressed by the RA-RNTI, the RAR message with fixed length may be transmitted as the DCI of the M-PDCCH. The fixed length may stand for fixed number of the MAC RAR. The M-PDCCH in which the RAR message is transmitted may be transmitted N repetition times according to the repetition level.

Referring to FIG. 8 again, The MTC terminal synchronizes the uplink time synchronization according to the TA, and transmit M3 through the uplink resource according to the UL grant (S805). And the contention resolution timer is started. The base station transmits a RRC connection setup message (that is, message 4 (M4)) addressed by the TC-RNTI to resolve a contention (S806). The RRC connection setup message includes the C-RNTI and the MTC physical channel configuration information.

If the M4 successfully received from the base station before the contention resolution timer is expired, the MTC terminal performs a state transition to RRC connected mode. Thereafter, the MTC terminal in the RRC connected mode may transmit new data or perform signaling procedure.

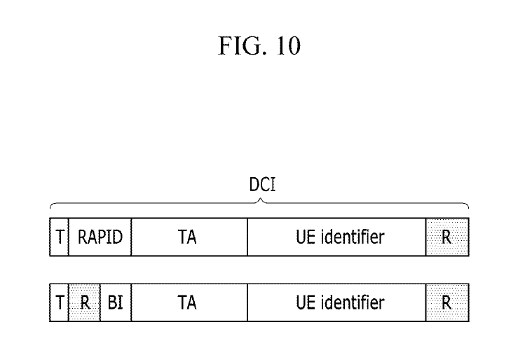

FIG. 10 is a schematic diagram illustrating a re-defined DCI format according to an exemplary embodiment.

In order to deliver the RAR message through the DCI, it is necessary to define a new DCI format. In this case, the DCI format include RAPID or BI. In addition, the DCI format may include a TA and a UE identifier. The uplink grant for the M3 such as the RRC connection request message may be included in the DCI in which the RAR message is transmitted, pre-determined, or be included in the MTC SIB.

According to the foregoing exemplary embodiment, by reducing the signaling procedure of the RA without impacting a delay time or an access of the normal terminal, a protocol and channel that are proper to a traffic pattern of the MTC terminal can be designed.

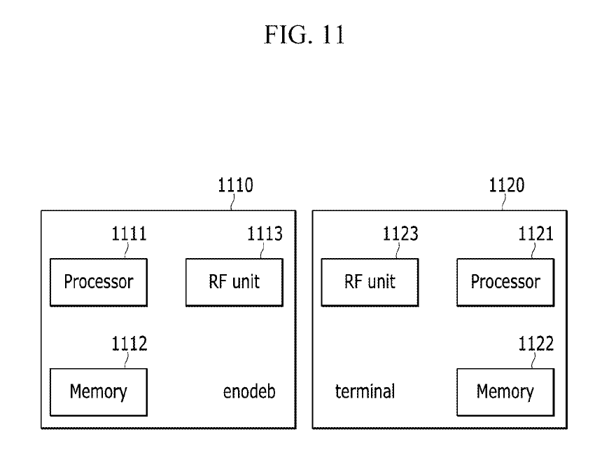

FIG. 11 is a block diagram illustrating a wireless communication system according to an exemplary embodiment.

Referring to FIG. 11, a wireless communication system according to an exemplary embodiment includes a base station 1110 and a terminal 1120.

The base station 1110 includes a processor 1111, a memory 1112, and a radio frequency (RF) unit (1113). The memory 1112 may be connected to the processor 1111 and may store a variety of information for driving the processor 1111 or at least one program executed by the processor 1111. The RF unit 1113 may be connected to the processor 1111, and may transmit and receive a wireless signal. The processor 1111 may implement the functions, the processes, or the methods proposed by the exemplary embodiments of the present disclosure. Here, a wireless interface protocol layer in a wireless communication system according to an exemplary embodiment of the present disclosure may be implemented by the processor 1111. An operation of the base station 1110 according to an exemplary embodiment may be implemented by the processor 1111.

The terminal 1120 includes a processor 1121, a memory 1122, and a RF unit 1123. The memory 1122 may be connected to the processor 1121 and may store a variety of information for driving the processor 1121 or at least one program executed by the processor 1121. The RF unit 1123 may be connected to the processor 1121, and may transmit and receive a wireless signal. The processor 1121 may implement the functions, the steps, or the methods proposed by the exemplary embodiments of the present disclosure. Here, a wireless interface protocol layer in a wireless communication system according to an exemplary embodiment of the present disclosure may be implemented by the processor 1121. An operation of the terminal 1120 according to an exemplary embodiment may be implemented by the processor 1121.

According to the exemplary embodiment of the present disclosure, the memory may be internal or external of the processor, and may be connected to the processor by various means which are already known. The memory is a variety of types of volatile or non-volatile storing medium. For example, the memory may include a read-only memory (ROM) or a random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for random access of a terminal, the method comprising:
transmitting a preamble to a base station;
receiving a first random access response (RAR) message of at least one RAR messages which is multiplexed by the base station based on the preamble from the base station; and
transmitting a scheduled message based on the first RAR message to the base station,
wherein the first RAR message is addressed to the terminal.

2. The method of claim 1, wherein:
the terminal is a machine type communication (MTC) terminal, and the receiving comprises receiving the first RAR message carried by downlink control information (DCI) of a physical downlink control channel for MTC (M-PDCCH).

3. The method of claim 1, wherein:
the terminal is a machine type communication (MTC) terminal, and the receiving comprises receiving the first RAR message through a physical downlink shared channel (PDSCH) which is scheduled by a physical downlink control channel for MTC (M-PDCCH).

4. The method of claim 1, wherein:
the at least one RAR message includes a media access control (MAC) header and a RAR payload, and the RAR payload includes at least one of a temporary C-RNTI (TC-RNTI), a timing advance (TA), or an uplink grant (UL grant).

5. The method of claim 2, wherein:
a DCI format of the DCI includes a random access preamble identifier (RAPID) or a backoff indicator (BI).

6. The method of claim 5, wherein:
the DCI format further includes a timing advance (TA) and a user equipment identifier (UE identifier).

7. The method of claim 1, wherein:
the transmitting a preamble to a base station comprises selecting the preamble in a group of a plurality of groups, and transmitting the selected preamble.

8. The method of claim 7, wherein:
a first group of the plurality of groups includes at least one preamble which is to be used for initial access to a network by the terminal, and a second group of the plurality of groups includes at least one preamble which is to be used for re-access to the network by the terminal.

9. The method of claim 1, further comprising:
receiving parameters pertinent to a random access channel (RACH) from the base station before transmitting the preamble, wherein the parameters pertinent to the RACH include at least one of group information of a machine type communication (MTC) preamble, a repetition level of the RACH, an MTC RA response Window Size, or an MTC contention resolution timer.

10. A terminal for performing random access comprising:
at least one processor;
a memory; and
a wireless communication unit,
wherein the at least one processor executes at least one program stored in the memory to perform:
transmitting a preamble to a base station;
receiving a first random access response (RAR) message of at least one RAR messages which is multiplexed by the base station based on the preamble from the base station; and
transmitting a scheduled message based on the first RAR message to the base station,
wherein the first RAR message is addressed to the terminal.

11. The terminal of claim 10, wherein:
the terminal is a machine type communication (MTC) terminal, and
during the receiving, the at least one processor performs
receiving the first RAR message carried by downlink control information (DCI) of a physical downlink control channel for MTC (M-PDCCH).

12. The terminal of claim 10, wherein:
the terminal is a machine type communication (MTC) terminal, and
during the receiving, the at least one processor performs
receiving the first RAR message through a physical downlink shared channel (PDSCH) which is scheduled by a physical downlink control channel for MTC (M-PDCCH).

13. The terminal of claim 10, wherein the at least one RAR message includes a media access control (MAC) header and a RAR payload, and the RAR payload includes at least one of a temporary C-RNTI (TC-RNTI), a timing advance (TA), or an uplink grant (UL grant).

14. The terminal of claim 11, wherein a DCI format of the DCI includes a random access preamble identifier (RAPID) or a backoff indicator (BI).

15. The terminal of claim 14, wherein the DCI format further includes a timing advance (TA) and a user equipment identifier (UE identifier).

16. The terminal of claim 10, wherein:
during the transmitting, the at least one processor performs
selecting the preamble in a group of a plurality of groups, and transmitting the selected preamble.

17. The terminal of claim 16, wherein:
a first group of the plurality of groups includes at least one preamble which is to be used for initial access to a network by the terminal, and a second group of the plurality of groups includes at least one preamble which is to be used for re-access to the network by the terminal.

18. The terminal of claim 10, wherein:
the at least one processor further performs receiving parameters pertinent to a random access channel (RACH) from the base station before the transmitting the preamble, wherein the parameters pertinent to the RACH include at least one of group information of a machine type communication (MTC) preamble, a repetition level of the RACH, an MTC RA response Window Size, or an MTC contention resolution timer.

19. A method for supporting random access of a terminal, the method comprising:
multiplexing at least one random access response (RAR) message based on a preamble which is received from the terminal; and
receiving a scheduled message based on a first RAR message of the at least one RAR message.

20. The method of claim 19, further comprising:
transmitting parameters pertinent to a random access channel (RACH), wherein the parameters pertinent to the RACH include at least one of group information of a machine type communication (MTC) preamble, a repetition level of the RACH, an MTC RA response Window Size, or an MTC contention resolution timer.
